(19) United States
(12) Patent Application Publication
(10) Pub. No.: US 2016/0226647 A1
(43) Pub. Date: Aug. 4, 2016

(54) REFERENCE PRECODING VECTORS FOR MULTIPLE RANK INDICATIONS FOR CHANNEL QUALITY INDICATION (CQI) REPORTING IN A WIRELESS

(71) Applicant: NOKIA SOLUTIONS AND NETWORKS OY

(72) Inventors: Xiaoyi WANG, Hoffman Estates, IL (US); Bishwarup MONDAL, Beavercreek, OH (US); Eugene VISOTSKY, Buffalo Grove, IL (US)

(21) Appl. No.: 14/610,632

(22) Filed: Jan. 30, 2015

(51) Int. Cl. H04L 5/00; H04B 7/04

(52) U.S. Cl. CPC H04L 5/0057; H04B 7/0486; H04L 5/006; H04W 88/08

(57) ABSTRACT

An example technique may include determining, by a user device, a reference precoding vector for each of a plurality of rank indications, selecting, by the user device, a rank indication of the plurality of rank indications for data transmission based on reference signals received from the base station and the reference precoding vector for each rank indication, sending, from the user device to the base station, the selected rank indication for data transmission, determining, by the user device, one or more channel quality indications (CQIs) for the data transmission based on the reference signals received from the base station, the selected rank indication and the reference precoding vector for the selected rank indication, and sending, by the user device to the base station, the determined one or more channel quality indications (CQIs) for the selected rank indication.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments. Various features and improves are also being developed for 5G wireless networks.

### SUMMARY

According to an example implementation, a method may include determining, by a user device, a reference precoding vector for each of a plurality of rank indications, selecting, by the user device, a rank indication of the plurality of rank indications for data transmission based on reference signals received from the base station and the reference precoding vector for each rank indication, sending, from the user device to the base station, the selected rank indication for data transmission, determining, by the user device, one or more channel quality indications (CQIs) for the data transmission based on the reference signals received from the base station, the selected rank indication and the reference precoding vector for the selected rank indication, and sending, by the user device to the base station, the determined one or more channel quality indications (CQIs) for the selected rank indication.

According to another example implementation, an apparatus may include at least one processor and at least one memory including computer instructions, when executed by the at least one processor, cause the apparatus to: determine, by a user device, a reference precoding vector for each of a plurality of rank indications, select, by the user device, a rank indication of the plurality of rank indications for data transmission based on reference signals received from the base station and the reference precoding vector for each rank indication, send, from the user device to the base station, the selected rank indication for data transmission, determine, by the user device, one or more channel quality indications (CQIs) for the data transmission based on the reference signals received from the base station, the selected rank indication and the reference precoding vector for the selected rank indication, and send, by the user device to the base station, the determined one or more channel quality indications (CQIs) for the selected rank indication.

According to another example implementation, a computer program product may include a computer-readable storage medium and storing executable code that, when executed by at least one data processing apparatus, is configured to cause the at least one data processing apparatus to perform a method including: determining, by a user device, a reference precoding vector for each of a plurality of rank indications, selecting, by the user device, a rank indication of the plurality of rank indications for data transmission based on reference signals received from the base station and the reference precoding vector for each rank indication, sending, from the user device to the base station, the selected rank indication for data transmission, determining, by the user device, one or more channel quality indications (CQIs) for the data transmission based on the reference signals received from the base station, the selected rank indication and the reference precoding vector for the selected rank indication, and sending, by the user device to the base station, the determined one or more channel quality indications (CQIs) for the selected rank indication.

According to another example implementation, a method may include sending, by a base station to a user device, information identifying a reference precoding vector for each of a plurality of rank indications, sending, by the base station, reference signals to the user device, receiving, by the base station from the user device, a selected rank indication of the plurality of rank indications for data transmission based on the reference signals, and receiving, by the base station from the user device, one or more channel quality indications (CQIs) for the selected rank indication.

According to another example implementation, an apparatus may include at least one processor and at least one memory including computer instructions, when executed by the at least one processor, cause the apparatus to: send, by a base station to a user device, information identifying a reference precoding vector for each of a plurality of rank indications, send, by the base station, reference signals to the user device, receive, by the base station from the user device, a selected rank indication of the plurality of rank indications for data transmission based on the reference signals, and receive, by the base station from the user device, one or more channel quality indications (CQIs) for the selected rank indication.

According to another example implementation, a computer program product may include a computer-readable storage medium and storing executable code that, when executed by at least one data processing apparatus, is configured to cause the at least one data processing apparatus to perform a method including: sending, by a base station to a user device, information identifying a reference precoding vector for each of a plurality of rank indications, sending, by the base station, reference signals to the user device, receiving, by the base station from the user device, a selected rank indication of the plurality of rank indications for data transmission based on the reference signals, and receiving, by the base station from the user device, one or more channel quality indications (CQIs) for the selected rank indication.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating operation of a base station and a user device according to an example implementation.

FIG. 3 is a flow chart illustrating operation of a user device according to an example implementation.

FIG. 4 is a flow chart illustrating operation of a base station according to an example implementation.

FIG. 5 is a block diagram of a wireless station (e.g., BS or user device) according to an example implementation.

### DETAILED DESCRIPTION

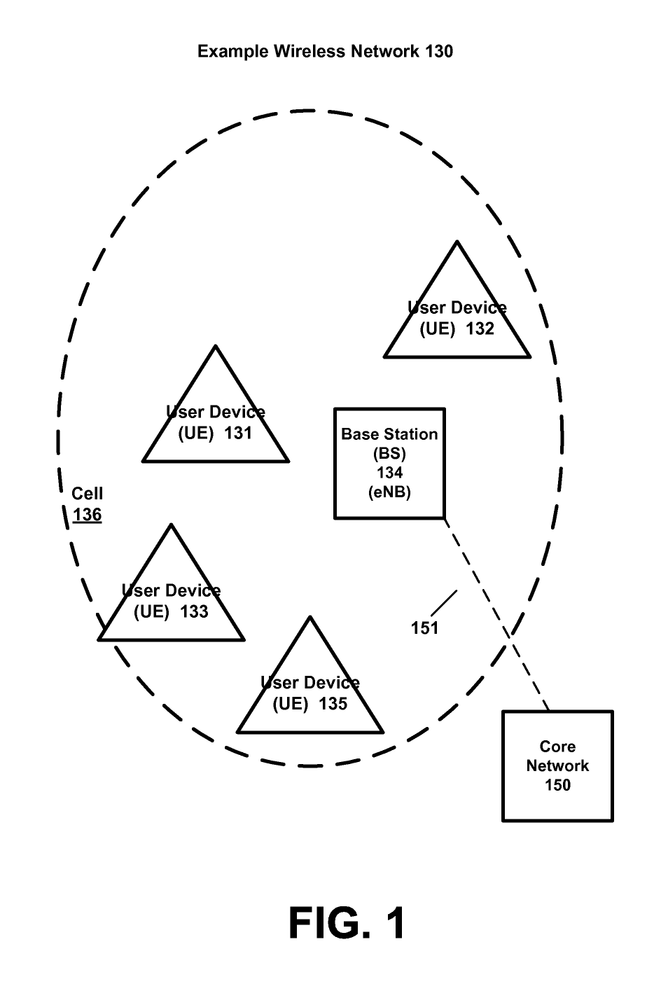

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B (eNB) may be also be carried out by any node, server or host which may be operably coupled to a transceiver, such as a remote radio head. BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), the core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

According to an example implementation, the channel or channel station information (CSI) may refer to a change in amplitude and/or phase that a signal undergoes when the signal is transmitted over the channel. In the case of TDD (time division duplex) reciprocity, it may be assumed that the uplink channel is approximately reciprocal with the downlink channel. Therefore, according to TDD reciprocity, the channel state information (CSI) (or simply the channel) for an uplink channel may be determined/estimated from a known downlink channel, and the channel or CSI for a downlink channel may be determined/estimated from a known uplink channel, based on the TDD reciprocity of the uplink/downlink channels, for example.

According to an example implementation, a base station (BS) may receive reference signals (RSs), e.g., sounding reference signals from a user device. The BS may determine the uplink channel, e.g., change in amplitude and phase of the reference signals over the uplink channel. Based on the uplink channel (and based on TDD reciprocity), the BS may determine a channel precoding vector to perform channel precoding for downlink transmissions, e.g., to compensate for the distortion (e.g., change in amplitude and/or phase) effects of the estimated downlink channel, where the downlink channel may be determined or estimated from the uplink channel, based on TDD reciprocity, according to an example implementation. For example, the BS may use a channel precoding vector to perform downlink channel precoding. For example, based on the uplink channel and TDD reciprocity, the BS may select a channel precoding vector (or simply a precoder), which may include one or more antenna weights to be applied to the BS antenna arrays/antenna elements for transmitting to the user device. For example, each antenna weight for the channel precoding vector may include an amplitude and/or phase to be applied to (pre-distort) transmitted signals, e.g., to compensate for the estimated downlink channel effects.

While the uplink channel and the downlink channel (e.g., change is amplitude and phase for a transmitted signal over a channel) may be considered to be substantially reciprocal (e.g., in the case of TDD reciprocity), the interference and/or noise on the uplink and downlink channels are not typically the same or reciprocal. Thus, according to an illustrative example, interference and/or noise may need to be measured/determined separately for uplink and downlink channels between the BS and the user device.

In addition, for some wireless systems, such as for multiple-input, multiple-output (MIMO) systems, a user device may measure one or more qualities of the downlink channel and may provide feedback to the base station that may include one or more of: a channel quality indication (CQI) that identifies the downlink channel quality (e.g., a quantized SINR of the downlink channel), a Rank Indication (RI) and a Precoding Matrix Indicator (PMI). However, in a case of TDD reciprocity, the BS may simply measure the uplink channel (CSI) and then assume the downlink channel is reciprocal, and then determine or select a channel precoding vector to use for channel precoding for downlink transmissions based on TDD reciprocity. Thus, in the case of TDD reciprocity, it may not be necessary for the user device to measure the downlink channel and then feed back a PMI (precoding matrix indicator) to the BS that identifies a channel precoding vector to be used by the BS for downlink transmissions, since the BS can determine/estimate a channel precoding vector to be used for downlink transmissions, for example.

A user device may determine a Rank Indication (RI) and a channel quality indication (CQI) for the downlink channel, e.g., based on reference signals received by the user device from the BS. In the example case of a MIMO wireless system, the user device may select/determine a Rank Indication (RI) for the downlink channel between the BS and user device, e.g., to be used for BS to transmit data/signals to the user device. For example, the RI may typically indicate the number of spatial transmission layers that may be used for the MIMO channel between the BS and the user device, e.g., up to four spatial transmission layers for the downlink MIMO channel between the BS and user device. The RI also indicates the number of symbols that the receiver/user device can receive at the same time, e.g., one symbol, two symbols, three symbols, or four symbols at a time, depending on the channel and the number of antenna arrays at the receiver/user device. For example, if the user device includes two antennas/antenna arrays (where an antenna or antenna array may include one or more antenna elements), then the user device may receive either one or two symbols at a time, and there may be either one or two spatial transmission layers for the downlink channel (corresponding to RI=1, RI=2).

Also, according to an example implementation, a precoding matrix indicator (PMI) may be used to specify/identify a channel precoding vector. The PMI may index to a precoding matrix, and thereby identify the parameters (e.g., amplitude and/or phase values for one or more antennas/antenna arrays) of a corresponding channel precoding vector.

Also, according to an example implementation, as noted above, a user device may measure and report a channel quality of the downlink channel, e.g., which may include, for example, the user device measuring the signal-to-interference-plus-noise ratio (SINR), quantizing the SINR to a CQI value, and then sending or feeding back the CQI for the downlink channel to the BS. According to an example implementation, the BS may then use the received CQI to select an appropriate modulation scheme and coding rate, which may also be referred to as a modulation and coding scheme (MCS), for the BS to transmit data via the downlink channel from the BS to the user device.

As noted, the user device may determine a RI and CQI for a downlink channel based on reference signals received by the user device from the BS. According to an example implementation, the BS may send the reference signals to the user device using channel precoding, e.g., where channel precoding may include a weight (e.g., amplitude and/or phase) applied to each of one or more antennas/antenna arrays. The channel precoding weights are described by a channel precoding vector. However, the user device may not know which channel precoding vector the BS has used/will use to determine the CQI values. Therefore, according to an example implementation, the BS and the user device may agree in advance that the user device will determine the CQI values, and the BS will interpret the received CQI(s) based on or using a reference (or default) precoding vector. Thus, the reference precoding vector for a selected RI may be used as a reference point for the user device to determine/measure the CQIs for the RI and/or for the BS to interpret the CQIs for the RI.

Therefore, according to an example implementation, a reference (or default) channel precoding vector (which may be referred to as a reference precoding vector) may be used (or may be assumed to be used by both BS and user device) by the user device to measure/determine the one or more CQI(s) for the selected RI. The user device may then report the selected RI and the one or more CQIs of the downlink channel to the BS. The BS may similarly assume that the reported CQI is based on the reference precoding vector of the selected RI being used as a reference by the user device to measure or determine the downlink CQI, for example. The reference precoding vector may also be referred to as a reference transmission scheme or TxD.

According to an example implementation, multi-Rank adaptation may be supported by, for example, by the BS pre-configuring the user device with a reference (or default) precoding vector for each Rank Indication (RI) for a plurality of rank indications. For example, the BS may send a configuration message to the user device that indicates a PMI for each RI, such as, for example: PMI 1, identifying a first reference precoding vector to be used for RI=1; PMI 2, identifying a second reference precoding vector to be used for RI=2; PMI 3, identifying a third reference precoding vector to be used for RI=3; and, PMI 4, identifying a fourth reference precoding vector to be used for RI=4, as an example. Each PMI for an RI may identify a reference precoding vector to be used for measuring and/or reporting CQI for that RI. Although in some cases, only rank indications (RIs) of either one or two may be used, e.g., for user devices having only two antennas/two antenna arrays.

Thus, according to an example implementation, a user device may select/determine a RI for the downlink MIMO channel, e.g., either RI=1, or RI=2, for a downlink data transmission based on received reference signals from the base station and the reference precoding vector for each of the rank indications, in order to determine or select the best rank indication (RI) to be used by the BS for (a next or upcoming) downlink data transmission to the user device. The user device may then send or communicate the RI to the BS, e.g., for the BS to use the selected RI for an upcoming downlink data transmission to the user device. The user device may then determine one or more CQIs for the (upcoming) transmission based on the selected RI, the received reference signals and the reference precoding vector for the selected RI, according to an example implementation.

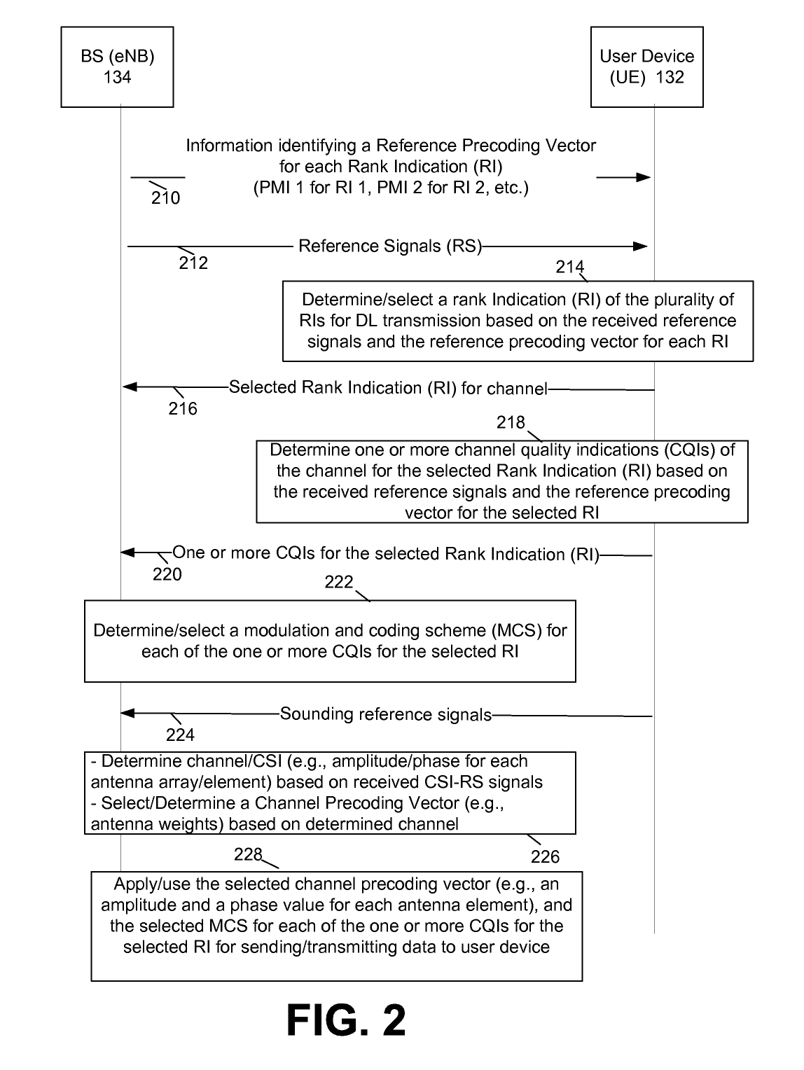

FIG. 2 is a diagram illustrating operation of a base station and a user device according to an example implementation. At 210, information may be sent by BS 134 to user device 132 that identifies a reference precoding vector for each of a plurality of rank indications. For example, at 210, as part of the BS 134 configuring the user device 132, the BS 134 may send a configuration message that includes a PMI (precoding matrix indicator) to specify/identify a reference (or default) precoding vector for measuring and/or reporting of CQI for each RI. Thus, a PMI may be indicated for each RI. For example, the following example PMIs may be used to identify reference precoding vectors for each RI: PMI 1 for RI=1; PMI 2 for RI=2; PMI 3 for RI=3; and PMI 4 for RI=4. These are merely some examples, where each PMI may point or index to one vector/entry of a matrix of channel precoding vectors, for example.

Note that the reference precoding vector may be assumed by both the user device and BS to be used measuring/determining the CQI by the user device and interpreting the CQIs by the BS. Thus, a reference precoding vector may be used as a common reference point by both user device and BS for a selected RI for: determining CQIs (by the user device) and interpreting received CQIs (by the BS).

At 212, the BS 134 sends/transmits reference signals (RSs) to one or more user devices, such as to user device 132. At 214, the user device 132 may determine or select a rank indication (RI) of the plurality of rank indications (RIs) based on the reference signals received from the BS 134 and the reference precoding vector for each RI. For example, the user device 132 may select the best RI (e.g., to be used for a next/upcoming downlink transmission from the BS to the user device) based on the received reference signals and the reference precoding vector for each of the RIs.

At 216, the user device 132 may send a message to the BS 134 indicating the selected rank indication (RI) for the downlink channel. For example, the selected RI may be reported as RI=1, RI=2, RI=3, or RI=4.

At 218, the user device 132 may determine or measure one or more CQIs of the downlink channel for the selected rank indication (RI) based on the received reference signals and the reference precoding vector for the selected RI. In an example implementation, the number of reported CQIs for the selected RI may be based on the selected RI. In one example implementation, the number of reported CQIs for a selected RI may be the same as the selected RI, e.g., one CQI reported for each spatial transmission layer of the downlink MIMO channel. For example, one CQI value may be determined and reported by the user device for a downlink channel where a RI=1 is selected; two CQI values may be determined and reported by the user device for a downlink channel where a RI=2 is selected; three CQI values may be determined and reported by the user device for a downlink channel where a RI=3 is selected; and, four CQI values may be determined and reported by the user device for a downlink channel where a RI=4 is selected. These are merely some examples, and other numbers of RI may be used.

At 220, the user device 132 sends a message to the BS 134 indicating the one or more CQIs for the selected RI. According to one example implementation, the selected RI at 216 may be sent from the user device 132 to the BS 134 via a first message, and the one or more reported CQIs at 220 may be sent or transmitted by the user device 132 to the BS 134 via a second message. In a second example implementation, one message may be sent from the user device 132 to the BS 134 that indicates/identifies both the selected RI and the one or more CQIs for the selected RI. According to an example implementation, the selected RI and the one or more CQIs for the selected RI may be reported by the user device to the BS to allow the BS to transmit data/signals to the user device based on the selected RI and the reported CQI(s). In other words, the BS may select or configure one or more transmission parameters for downlink transmission to the user device based on the selected RI and the reported CQIs for the RI.

For example, at 222, the BS 134 may determine or select a modulation and coding scheme (MCS) for each of the one or more CQIs for the selected RI. At 224, the BS 134 may receive sounding reference signals from user device 132. At 226, BS 134 may determine the channel (e.g., amplitude and/or phase change of signals transmitted to the BS 134 via the uplink channel from the user device 132) based on the received sounding reference signals at 224. Based on TDD reciprocity (e.g., assuming that the uplink channel and the downlink channel between the BS 134 and the user device 132 are reciprocal or substantially reciprocal), the BS may then select or determine a channel precoding vector (e.g., which may include antenna weights) to be used for transmitting downlink data/signals from the BS 134 to the user device 132. The BS 134 may select or determine the channel precoding vector for transmitting downlink based on the determined channel that was determined by the BS 134 for the uplink channel.

At 228, the BS 134 may apply or use the selected channel precoding vector (which may be antenna weights, e.g., an antenna amplitude and phase value, determined at 226) and the selected MCS (determined/selected at 222) for one or more CQIs for the selected RI to transmit data via the downlink channel to the user device 132. Thus, for example, the BS 134 may transmit data via the downlink channel to the user device 132 by applying the selected MCS(s) to code the data and then applying antenna weights (e.g., amplitude and/or phase values) of the selected channel precoding vector to each antenna/antenna array to transmit data.

Therefore, according to an example implementation, multiple rank indications are supported by providing (e.g., by BS 134 preconfiguring user device 132) with a reference precoding vector for each RI of a plurality of RIs. For example, BS 134 may send a control/configuration message to user device 132 that includes a PMI to identify a reference (default) precoding vector for each RI of a plurality of RIs. According to an example implementation, BS 134 may send reference signals to the user device 132. The user device may determine/select a RI for the channel based on the reference signals and the reference precoding vector for each RI, e.g., in order to select a best RI. One or more CQIs may be determined by user device 132 for the selected RI based on reference signals received by the user device 132 from the BS, the selected RI and the reference precoding vector for the selected RI. The user device 132 may then send or report the selected RI and one or more CQIs for the selected RI to the BS 134. The BS 134 may then use the selected RI and the one or more CQIs for the selected RI to transmit data to the user device 132. For example, by the BS 134 notifying (e.g., via preconfiguring the user device 132) user device 132 of a reference precoding vector for each RI of a plurality of RIs, multiple rank adaptation may be supported, without requiring the user device 132 to notify the BS 134 of the PMI to be used for a selected RI. Rather, both the user device 132 and the BS 134 may be pre-configured with the PMI of the reference precoding vector to be used for each RI for a plurality of RIs, e.g., for determining and interpreting CQIs.

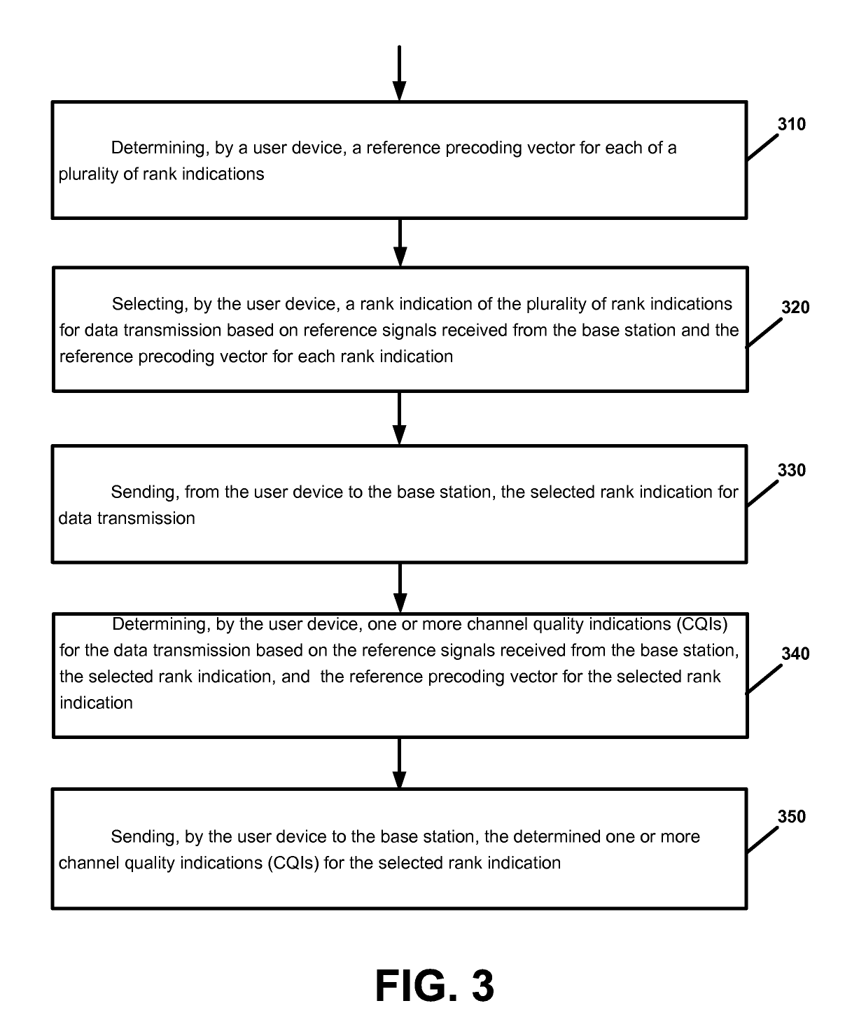

FIG. 3 is a flow chart illustrating operation of a user device according to an example implementation. Operation 310 includes determining, by a user device, a reference precoding vector for each of a plurality of rank indications. Operation 320 includes selecting, by the user device, a rank indication of the plurality of rank indications for data transmission based on reference signals received from the base station and the reference precoding vector for each rank indication; Operation 330 includes sending, from the user device to the base station, the selected rank indication for data transmission. Operation 340 includes determining, by the user device, one or more channel quality indications (CQIs) for the data transmission based on the reference signals received from the base station, the selected rank indication and the reference precoding vector for the selected rank indication; And, operation 350 includes sending, by the user device to the base station, the determined one or more channel quality indications (CQIs) for the selected rank indication.

According to an example implementation of the method of FIG. 3, the determining, by the user device, a reference precoding vector for each of a plurality of rank indications may include: receiving, by the user device from the base station, information identifying a reference precoding vector for each of a plurality of rank indications.

According to an example implementation of the method of FIG. 3, the determining, by the user device, a reference precoding vector for each of a plurality of rank indications may include at least: receiving, by the user device from the base station, information identifying a first reference precoding vector for a first rank indication and information identifying a second reference precoding vector for a second rank indication.

According to an example implementation of the method of FIG. 3, the receiving, by the user device from the base station, information identifying a first reference precoding vector for a first rank indication and information identifying a second reference precoding vector for a second rank indication may include: receiving, by the user device, a first precoding matrix indicator (PMI) that identifies the first reference precoding vector for the first rank indication; and receiving, by the user device, a second precoding matrix indicator (PMI) that identifies the second reference precoding vector for the second rank indication.

According to an example implementation of the method of FIG. 3, the channel quality indication (CQI) of the channel for the selected rank indication is based on a measured signal-to-interference-plus-noise ratio (SINR) for the channel.

According to an example implementation of the method of FIG. 3, a number of determined channel quality indications (CQIs) for the selected rank indication is based on the rank indication, wherein one CQI is determined for a rank indication of one, and two CQIs are determined for a rank indication of two.

According to an example implementation of the method of FIG. 3, for a rank indication larger than one, the one or more channel quality indications (CQIs) include multiple CQIs, with each of the multiple CQIs associated with one encoder.

According to another example implementation, an apparatus may include at least one processor and at least one memory including computer instructions, when executed by the at least one processor, cause the apparatus to: determine, by a user device, a reference precoding vector for each of a plurality of rank indications, select, by the user device, a rank indication of the plurality of rank indications for data transmission based on reference signals received from the base station and the reference precoding vector for each rank indication, send, from the user device to the base station, the selected rank indication for data transmission, determine, by the user device, one or more channel quality indications (CQIs) for the data transmission based on the reference signals received from the base station, the selected rank indication and the reference precoding vector for the selected rank indication, and send, by the user device to the base station, the determined one or more channel quality indications (CQIs) for the selected rank indication.

According to an example implementation, causing the apparatus to determine, by the user device, a reference precoding vector for each of a plurality of rank indications includes causing the apparatus to: receive, by the user device from the base station, information identifying a reference precoding vector for each of a plurality of rank indications.

According to an example implementation, causing the apparatus to determine, by the user device, a reference precoding vector for each of a plurality of rank indications includes causing the apparatus to at least: receive, by the user device from the base station, information identifying a first reference precoding vector for a first rank indication and information identifying a second reference precoding vector for a second rank indication.

According to an example implementation, causing the apparatus to receive, by the user device from the base station, information identifying a first reference precoding vector for a first rank indication and information identifying a second reference precoding vector for a second rank indication includes causing the apparatus to: receive, by the user device, a first precoding matrix indicator (PMI) that identifies the first reference precoding vector for the first rank indication; and receive, by the user device, a second precoding matrix indicator (PMI) that identifies the second reference precoding vector for the second rank indication.

According to an example implementation, wherein the channel quality indication (CQI) of the channel for the selected rank indication is based on a measured signal-to-interference-plus-noise ratio (SINR) for the channel.

According to an example implementation, wherein a number of determined channel quality indications (CQIs) for the selected rank indication is based on the rank indication, wherein one CQI is determined for a rank indication equal to one, and two CQIs are determined for a rank indication equal to two.

According to an example implementation, a rank indication larger than one, the one or more channel quality indications (CQIs) include multiple CQIs, with each of the multiple CQIs associated with one encoder.

According to another example implementation, a computer program product includes a computer-readable storage medium and storing executable code that, when executed by at least one data processing apparatus, is configured to cause the at least one data processing apparatus to perform a method including: determining, by a user device, a reference precoding vector for each of a plurality of rank indications; selecting, by the user device, a rank indication of the plurality of rank indications for data transmission based on reference signals received from the base station and the reference precoding vector for each rank indication; sending, from the user device to the base station, the selected rank indication for data transmission; determining, by the user device, one or more channel quality indications (CQIs) for the data transmission based on the reference signals received from the base station, the selected rank indication and the reference precoding vector for the selected rank indication; and sending, by the user device to the base station, the determined one or more channel quality indications (CQIs) for the selected rank indication.

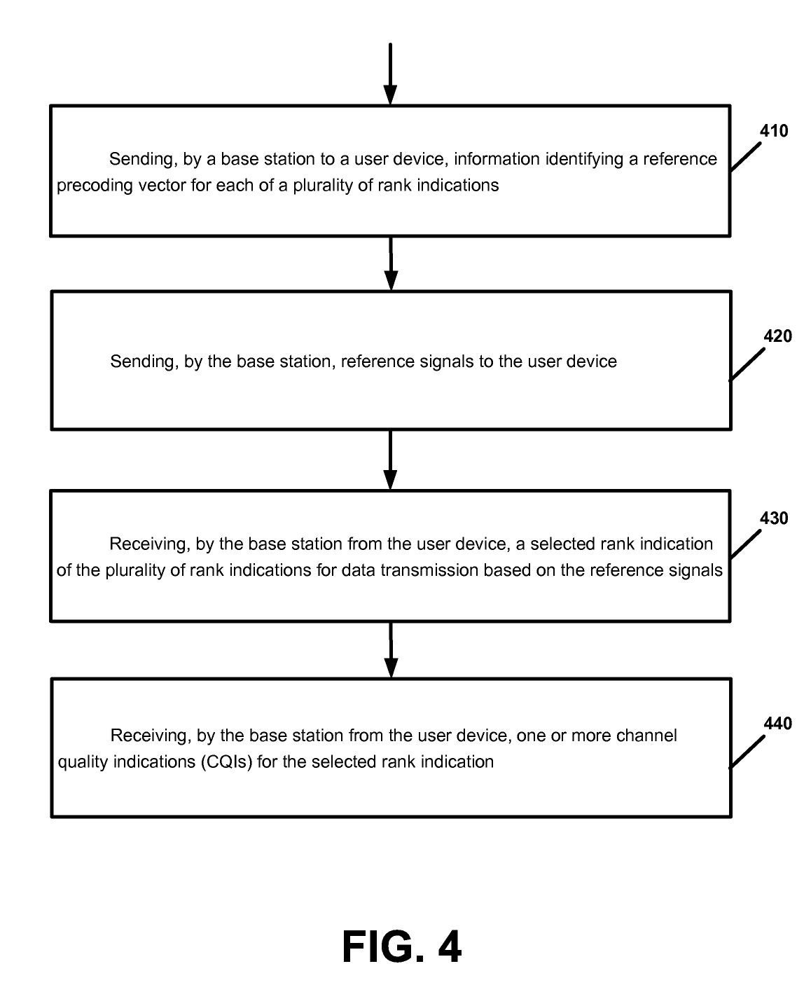

FIG. 4 is a flow chart illustrating operation of a base station according to an example implementation. Operation 410 includes sending, by a base station to a user device, information identifying a reference precoding vector for each of a plurality of rank indications. Operation 420 includes sending, by the base station, reference signals to the user device. Operation 430 includes receiving, by the base station from the user device, a selected rank indication of the plurality of rank indications for data transmission based on the reference signals. And, operation 440 includes receiving, by the base station from the user device, one or more channel quality indications (CQIs) for the selected rank indication.

According to an example implementation of the method of FIG. 4, the method may further include: determining, by the base station, a modulation and coding scheme (MCS) for each of the one or more CQIs received for the selected rank indication; and sending, by the base station to the user device, data to the user device based on the determined modulation and coding scheme (MCS) for each of the one or more CQIs for the selected rank indication.

According to an example implementation of the method of FIG. 4, the sending, by a base station to a user device, information identifying a reference precoding vector for each of a plurality of rank indications may include: sending, by the base station to the user device, a first precoding matrix indicator (PMI) that identifies a first reference precoding vector for a first rank indication; and sending, by the base station to the user device, a second precoding matrix indicator (PMI) that identifies a second reference precoding vector for a second rank indication.

According to another example implementation, an apparatus may include at least one processor and at least one memory including computer instructions, when executed by the at least one processor, cause the apparatus to: An apparatus comprising at least one processor and at least one memory including computer instructions, when executed by the at least one processor, cause the apparatus to: send, by a base station to a user device, information identifying a reference precoding vector for each of a plurality of rank indications; send, by the base station, reference signals to the user device; receive, by the base station from the user device, a selected rank indication of the plurality of rank indications for data transmission based on the reference signals; and, receive, by the base station from the user device, one or more channel quality indications (CQIs) for the selected rank indication.

According to an example implementation, the apparatus is further caused to: determine, by the base station, a modulation and coding scheme (MCS) for each of the one or more CQIs received for the selected rank indication; and send, by the base station to the user device, data to the user device based on the selected rank indication and the determined modulation and coding scheme (MCS) for each of the one or more CQIs for the selected rank indication.

According to an example implementation, the causing the apparatus to send, by a base station to a user device, information identifying a reference precoding vector for each of a plurality of rank indications may include causing the apparatus to: send, by the base station to the user device, a first precoding matrix indicator (PMI) that identifies a first reference precoding vector for a first rank indication; and send, by the base station to the user device, a second precoding matrix indicator (PMI) that identifies a second reference precoding vector for a second rank indication.

According to another example implementation, a computer program product may include a computer-readable storage medium and storing executable code that, when executed by at least one data processing apparatus, is configured to cause the at least one data processing apparatus to perform a method including: sending, by a base station to a user device, information identifying a reference precoding vector for each of a plurality of rank indications, sending, by the base station, reference signals to the user device, receiving, by the base station from the user device, a selected rank indication of the plurality of rank indications for data transmission based on the reference signals, and receiving, by the base station from the user device, one or more channel quality indications (CQIs) for the selected rank indication.

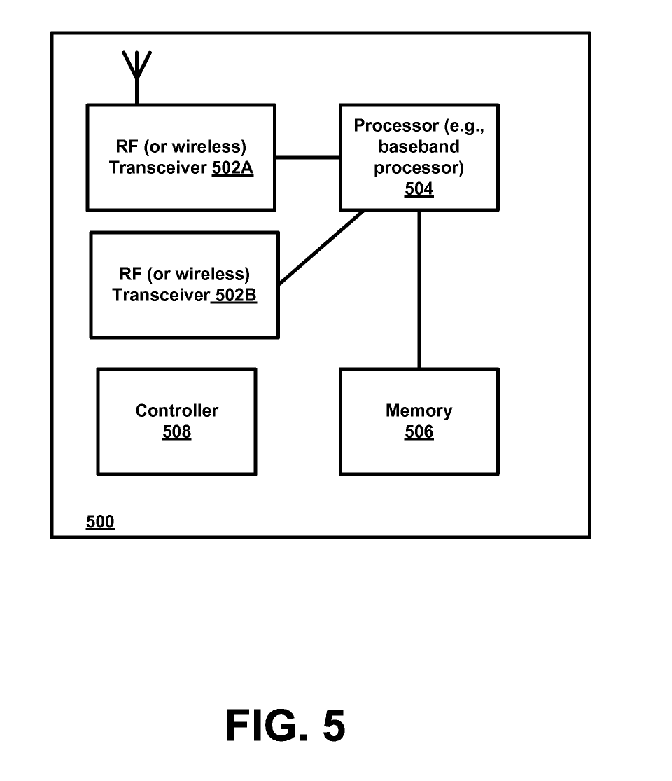

FIG. 5 is a block diagram of a wireless station (e.g., BS or user device) 500 according to an example implementation. The wireless station 500 may include, for example, two RF (radio frequency) or wireless transceivers 502A, 502B, where each wireless transceiver includes a transmitter to transmit signals and a receiver to receive signals. The wireless station also includes a processor or control unit/entity (controller) 504 to execute instructions or software and control transmission and receptions of signals, and a memory 506 to store data and/or instructions.

Processor 504 may also make decisions or determinations, generate frames, packets or messages for transmission, decode received frames or messages for further processing, and other tasks or functions described herein. Processor 504, which may be a baseband processor, for example, may generate messages, packets, frames or other signals for transmission via wireless transceiver 502 (502A or 502B). Processor 504 may control transmission of signals or messages over a wireless network, and may control the reception of signals or messages, etc., via a wireless network (e.g., after being down-converted by wireless transceiver 502, for example). Processor 504 may be programmable and capable of executing software or other instructions stored in memory or on other computer media to perform the various tasks and functions described above, such as one or more of the tasks or methods described above. Processor 504 may be (or may include), for example, hardware, programmable logic, a programmable processor that executes software or firmware, and/or any combination of these. Using other terminology, processor 504 and transceiver 502 together may be considered as a wireless transmitter/receiver system, for example.

In addition, referring to FIG. 5, a controller (or processor) 508 may execute software and instructions, and may provide overall control for the station 500, and may provide control for other systems not shown in FIG. 5, such as controlling input/output devices (e.g., display, keypad), and/or may execute software for one or more applications that may be provided on wireless station 500, such as, for example, an email program, audio/video applications, a word processor, a Voice over IP application, or other application or software.

In addition, a storage medium may be provided that includes stored instructions, which when executed by a controller or processor may result in the processor 504, or other controller or processor, performing one or more of the functions or tasks described above.

According to another example implementation, RF or wireless transceiver(s) 502A/502B may receive signals or data and/or transmit or send signals or data. Processor 504 (and possibly transceivers 502A/502B) may control the RF or wireless transceiver 502A or 502B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
determining, by a user device, a reference precoding vector for each of a plurality of rank indications;
selecting, by the user device, a rank indication of the plurality of rank indications for data transmission based on reference signals received from the base station and the reference precoding vector for each rank indication;
sending, from the user device to the base station, the selected rank indication for data transmission;
determining, by the user device, one or more channel quality indications (CQIs) for the data transmission based on the reference signals received from the base station, the selected rank indication and the reference precoding vector for the selected rank indication; and
sending, by the user device to the base station, the determined one or more channel quality indications (CQIs) for the selected rank indication.

2. The method of claim 1 wherein the determining, by the user device, a reference precoding vector for each of a plurality of rank indications comprises:
receiving, by the user device from the base station, information identifying a reference precoding vector for each of a plurality of rank indications.

3. The method of claim 1 wherein the determining, by the user device, a reference precoding vector for each of a plurality of rank indications comprises at least:
receiving, by the user device from the base station, information identifying a first reference precoding vector for a first rank indication and information identifying a second reference precoding vector for a second rank indication.

4. The method of claim 3 wherein the receiving, by the user device from the base station, information identifying a first reference precoding vector for a first rank indication and information identifying a second reference precoding vector for a second rank indication comprises:
receiving, by the user device, a first precoding matrix indicator (PMI) that identifies the first reference precoding vector for the first rank indication; and
receiving, by the user device, a second precoding matrix indicator (PMI) that identifies the second reference precoding vector for the second rank indication.

5. The method of claim 1 wherein the channel quality indication (CQI) of the channel for the selected rank indication is based on a measured signal-to-interference-plus-noise ratio (SINR) for the channel.

6. The method of claim 1 wherein a number of determined channel quality indications (CQIs) for the selected rank indication is based on the rank indication, wherein one CQI is determined for a rank indication equal to one, and two CQIs are determined for a rank indication equal to two.

7. The method of claim 1 wherein for a rank indication larger than one, the one or more channel quality indications (CQIs) include multiple CQIs, with each of the multiple CQIs associated with one encoder.

8. An apparatus comprising at least one processor and at least one memory including computer instructions, when executed by the at least one processor, cause the apparatus to:
determine, by a user device, a reference precoding vector for each of a plurality of rank indications;
select, by the user device, a rank indication of the plurality of rank indications for data transmission based on reference signals received from the base station and the reference precoding vector for each rank indication;
send, from the user device to the base station, the selected rank indication for data transmission;
determine, by the user device, one or more channel quality indications (CQIs) for the data transmission based on the reference signals received from the base station, the selected rank indication and the reference precoding vector for the selected rank indication; and
send, by the user device to the base station, the determined one or more channel quality indications (CQIs) for the selected rank indication.

9. The apparatus of claim 8 wherein causing the apparatus to determine, by the user device, a reference precoding vector for each of a plurality of rank indications comprises causing the apparatus to:
receive, by the user device from the base station, information identifying a reference precoding vector for each of a plurality of rank indications.

10. The apparatus of claim 8 wherein causing the apparatus to determine, by the user device, a reference precoding vector for each of a plurality of rank indications comprises causing the apparatus to at least:
receive, by the user device from the base station, information identifying a first reference precoding vector for a first rank indication and information identifying a second reference precoding vector for a second rank indication.

11. The apparatus of claim 10 wherein causing the apparatus to receive, by the user device from the base station, information identifying a first reference precoding vector for a first rank indication and information identifying a second reference precoding vector for a second rank indication comprises causing the apparatus to:
receive, by the user device, a first precoding matrix indicator (PMI) that identifies the first reference precoding vector for the first rank indication; and
receive, by the user device, a second precoding matrix indicator (PMI) that identifies the second reference precoding vector for the second rank indication.

12. The apparatus of claim 8 wherein the channel quality indication (CQI) of the channel for the selected rank indication is based on a measured signal-to-interference-plus-noise ratio (SINR) for the channel.

13. The apparatus of claim 8 wherein a number of determined channel quality indications (CQIs) for the selected rank indication is based on the rank indication, wherein one CQI is determined for a rank indication equal to one, and two CQIs are determined for a rank indication equal to two.

14. The apparatus of claim 8 wherein for a rank indication larger than one, the one or more channel quality indications (CQIs) include multiple CQIs, with each of the multiple CQIs associated with one encoder.

15. A computer program product, the computer program product comprising a computer-readable storage medium and storing executable code that, when executed by at least one data processing apparatus, is configured to cause the at least one data processing apparatus to perform a method comprising:
determining, by a user device, a reference precoding vector for each of a plurality of rank indications;
selecting, by the user device, a rank indication of the plurality of rank indications for data transmission based on reference signals received from the base station and the reference precoding vector for each rank indication;
sending, from the user device to the base station, the selected rank indication for data transmission;
determining, by the user device, one or more channel quality indications (CQIs) for the data transmission based on the reference signals received from the base station, the selected rank indication and the reference precoding vector for the selected rank indication; and
sending, by the user device to the base station, the determined one or more channel quality indications (CQIs) for the selected rank indication.

16. A method comprising:
sending, by a base station to a user device, information identifying a reference precoding vector for each of a plurality of rank indications;
sending, by the base station, reference signals to the user device;
receiving, by the base station from the user device, a selected rank indication of the plurality of rank indications for data transmission based on the reference signals;
receiving, by the base station from the user device, one or more channel quality indications (CQIs) for the selected rank indication.

17. The method of claim 16 wherein the receiving, by the base station from the user device, one or more channel quality indications (CQIs) for the selected rank indication comprises:
receiving, by the base station from the user device based on the reference precoding vector for the selected rank indication, one or more channel quality indications (CQIs) for the selected rank indication.

18. The method of claim 16 and further comprising:
determining, by the base station, a modulation and coding scheme (MCS) for each of the one or more CQIs received for the selected rank indication; and
sending, by the base station to the user device, data to the user device based on the selected rank indication and the determined modulation and coding scheme (MCS) for each of the one or more CQIs for the selected rank indication.

19. The method of claim 16 wherein the sending, by a base station to a user device, information identifying a reference precoding vector for each of a plurality of rank indications comprises:
sending, by the base station to the user device, a first precoding matrix indicator (PMI) that identifies a first reference precoding vector for a first rank indication; and
sending, by the base station to the user device, a second precoding matrix indicator (PMI) that identifies a second reference precoding vector for a second rank indication.

20. An apparatus comprising at least one processor and at least one memory including computer instructions, when executed by the at least one processor, cause the apparatus to:
send, by a base station to a user device, information identifying a reference precoding vector for each of a plurality of rank indications;
send, by the base station, reference signals to the user device;
receive, by the base station from the user device, a selected rank indication of the plurality of rank indications for data transmission based on the reference signals;
receive, by the base station from the user device, one or more channel quality indications (CQIs) for the selected rank indication.

21. The apparatus of claim 20 wherein the apparatus is further caused to:
determine, by the base station, a modulation and coding scheme (MCS) for each of the one or more CQIs received for the selected rank indication; and
send, by the base station to the user device, data to the user device based on the selected rank indication and the determined modulation and coding scheme (MCS) for each of the one or more CQIs for the selected rank indication.

22. The apparatus of claim 20 wherein causing the apparatus to send, by a base station to a user device, information identifying a reference precoding vector for each of a plurality of rank indications comprises causing the apparatus to:
send, by the base station to the user device, a first precoding matrix indicator (PMI) that identifies a first reference precoding vector for a first rank indication; and
send, by the base station to the user device, a second precoding matrix indicator (PMI) that identifies a second reference precoding vector for a second rank indication.
